(19) United States
(12) Patent Application Publication
(10) Pub. No.: US 2020/0208523 A1
(43) Pub. Date: Jul. 2, 2020

(54) SCREW COMPRESSOR

(71) Applicant: Dongguan Hesheng Electrical and Mechanical Co., Ltd., Dongguan (CN)

(72) Inventor: Benyi LIAO, Dongguan (CN)

(21) Appl. No.: 16/458,181

(22) Filed: Jun. 30, 2019

Related U.S. Application Data
(63) Continuation-in-part of application No. PCT/CN2019/070272, filed on Jan. 3, 2019.

(30) Foreign Application Priority Data
Dec. 26, 2018 (CN) 201811597112.4

(51) Int. Cl. F01C 1/16; F04B 35/04

(52) U.S. Cl. CPC F01C 1/165; F16C 2360/43; F04B 35/04

(57) ABSTRACT

A screw compressor, including: a housing including at least one air inlet and at least one air outlet; a screw rotor disposed in the housing, the screw rotor including a male screw and a female screw that engage with each other; and a drive motor that drives the screw rotor to rotate. The male screw includes a plurality of first sheets that are sequentially stacked, the outer edge of which is provided with a plurality of convex blades, and the convex blades of adjacent first sheets are staggered and stacked in sequence. The female screw includes a plurality of second sheets that are sequentially stacked, the outer edge of which is provided with a plurality of inwardly recessed arcuate grooves, and the arcuate grooves of adjacent second sheets are staggered and stacked in sequence.

### CROSS-REFERENCE TO RELATED APPLICATIONS

This application is a continuation-in-part of International Patent Application No. PCT/CN2019/070272 with an international filing date of Jan. 3, 2019, designating the United States, now pending, and further claims foreign priority benefits to Chinese Patent Application No. 201811597112.4 filed Dec. 26, 2018. The contents of all of the aforementioned applications, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to the field of compressors, and more particularly to a stacked rotor type screw compressor.

Conventional piston compressors produce violent vibration, much noise and heat in operation. All these shorten the service life of the compressors.

A screw compressor has relatively small vibration and noise. However, the male and female screws of the compressor are made in one piece, which involves special cutting tools and precision processing procedures. This leads to relatively high production costs.

### SUMMARY

Providing is a screw compressor that features relatively low production cost, high working efficiency, and stable working performance.

The disclosure provides a screw compressor, comprising: a housing comprising at least one air inlet and at least one air outlet; a screw rotor disposed in the housing, the screw rotor comprising a male screw and a female screw that engage with each other; and a drive motor that drives the screw rotor to rotate.

The male screw comprises a plurality of first sheets that are sequentially stacked, the outer edge of which is provided with a plurality of convex blades, and the convex blades of adjacent first sheets are staggered and stacked in sequence; the male screw is spiral and comprises a side in an arced array configuration; the female screw comprises a plurality of second sheets that are sequentially stacked, the outer edge of which is provided with a plurality of inwardly recessed arcuate grooves, and the arcuate grooves of adjacent second sheets are staggered and stacked in sequence; the female screw is spiral and comprises a side in an arced array configuration; the convex blades of the first sheets and the arcuate grooves of the second sheets engage with each other.

The screw of the compressor comprises a plurality of blades, which reduces the manufacturing difficulty and processing cost of the screw compressor, and improves the working efficiency of the screw compressor.

The drive motor can be connected to the screw rotor via a gear set to drive the male and female screws that engage with each other to rotate synchronously.

The offset angle between the convex blades of adjacent first sheets and the offset angle between the arcuate grooves of adjacent second sheets can be identical.

The female and male rotors can be highly engaged and rotate cooperatively.

The first sheets and the second sheets can be both circular, the first sheets stacked on each other can be in the shape of a spiral column to form the male screw, and the second sheets stacked on each other can be in the shape of a spiral column to form the male screw.

The screw compressor can further comprise a controller electrically connected to a control end of the drive motor to control the start, shutdown and rotational speed of the drive motor.

Advantages of the screw compressor according to embodiments of the disclosure are summarized as follows:

1) The manufacturing difficulty and production cost of the screw compressor are reduced;

2) The air between the female and male rotors has a high-speed flow, and thus the working efficiency of the screw compressor is improved; and

3) The working performance of the screw compressor is stable.

### BRIEF DESCRIPTION OF THE DRAWINGS

FIG. 1 is a schematic view of a screw compressor as described in the disclosure;

FIG. 2 is a schematic view of an internal structure of a screw compressor as described in the disclosure;

FIG. 3 is a schematic view of engaged rotors as described in the disclosure;

FIG. 4 is a schematic view of a male screw as described in the disclosure;

FIG. 5 is a schematic view of a female screw as described in the disclosure;

FIG. 6 is a top view of a female screw as described in the disclosure;

FIG. 7 is a top view of a male screw as described in the disclosure;

FIG. 8 is a top view of engaged male screws as described in the disclosure.

In the drawings, the following reference numbers are used: 1. Housing; 2. Male screw; 3. Female screw; 11. Air outlet; 12. Drive motor; 13. Gear set; 14. Controller; 21. First sheet; 31. Second sheet; 211. First axle hole; 212. Convex blade; 311. Second axle hole; 312. Arcuate groove.

### DETAILED DESCRIPTION

To further illustrate, examples detailing a screw compressor are described below. It should be noted that the following examples are intended to describe and not to limit the description.

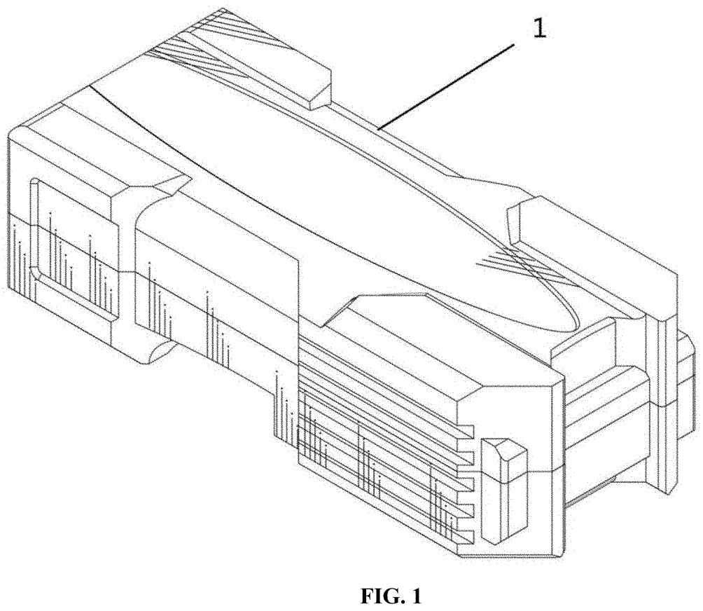

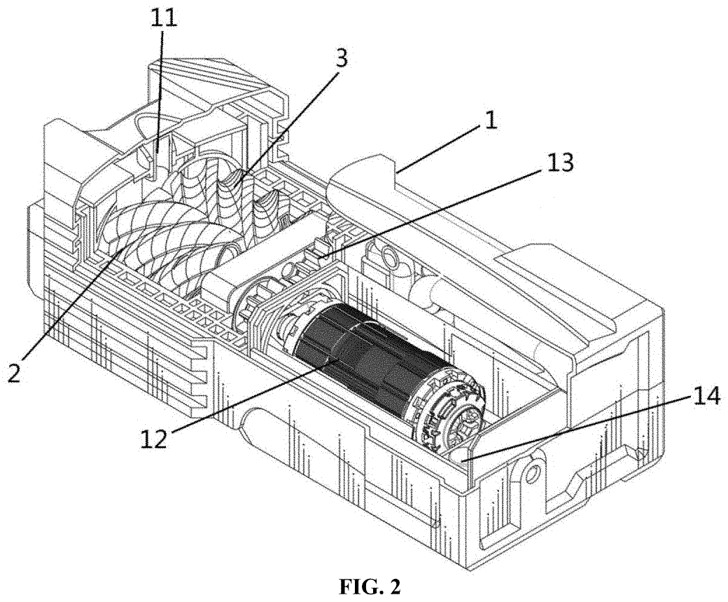

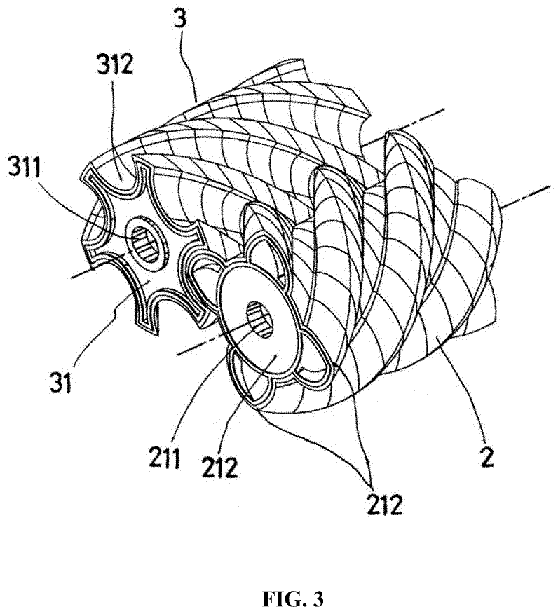

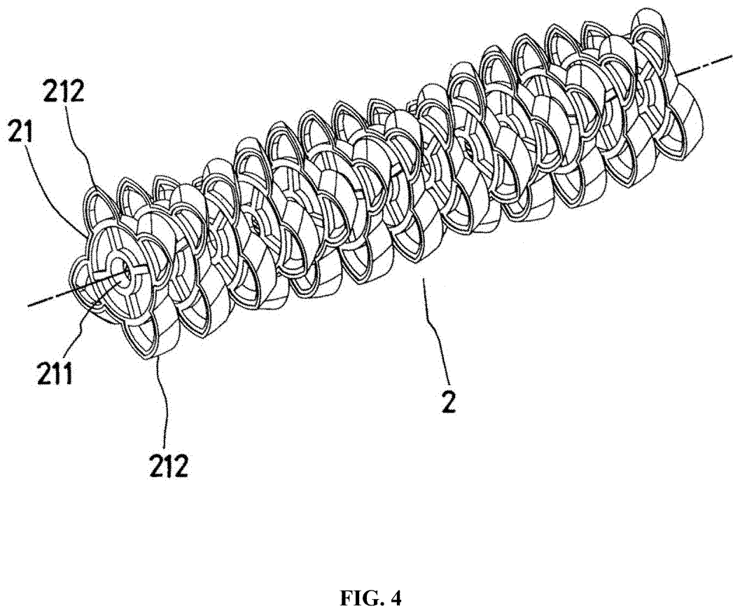

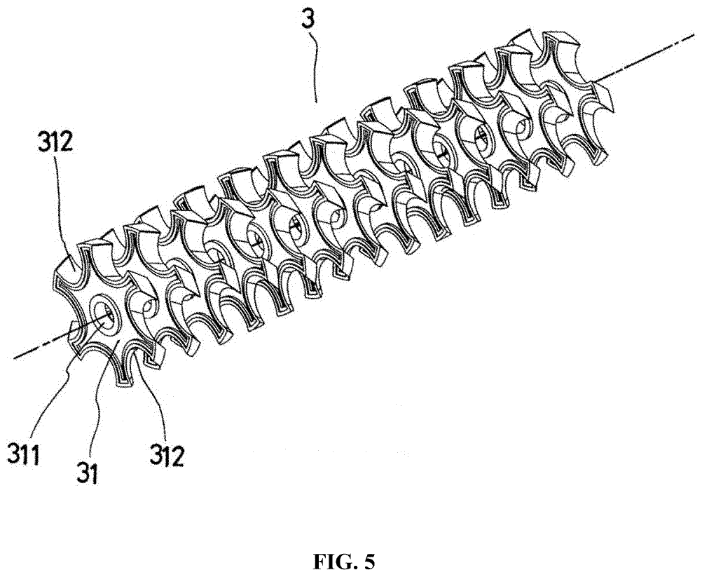

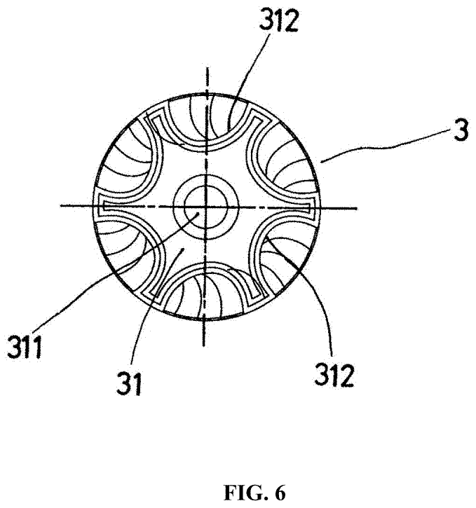

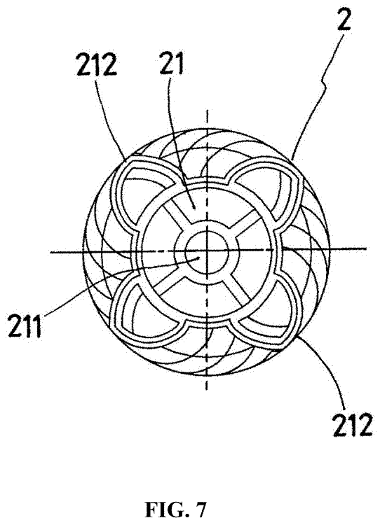

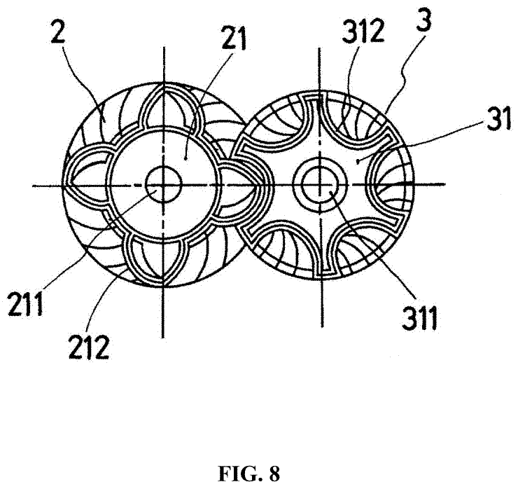

As shown in FIGS. 1-8, there is provided a stacked rotor type screw compressor comprising a housing 1 and a controller. The housing 1 is provided with at least one air inlet (not shown in figures) and at least one air outlet 11. The housing 1 comprises two chambers being a compression chamber and a motor chamber (which can also be disposed outside the housing 1). A drive motor 12 is disposed in the motor chamber. The input of the drive motor 12 is electrically connected to the output of the controller 14 disposed on the housing 1 of the screw compressor. The compression chamber is provided with two sets of screw rotors that engage with each other. The screw rotor comprises a male rotor and a female rotor that engage with each other. The male rotor comprises a first shaft and a male screw 2 rotating around the first shaft. The female rotor comprises a second shaft and a female screw 3 rotating around the second shaft. The male screw 2 and the female screw 3 engage with each other.

One end of the drive motor 12 next to the compression chamber is provided with a gear set 13. The gear set 13 comprises two gears that engage with each other. The drive motor 12 is connected to the first shaft or the second shaft via the gear set 13 to drive the first shaft or the second shaft.

The male screw 2 comprises a plurality of first sheets 21 that are sequentially stacked. The outer edge of each of the first sheets 21 is evenly provided with a plurality of convex blades 212. The first sheets 21 each comprise a first axle hole 211. The first axle hole 211 corresponds to the first shaft in diameters. The plurality of first sheets 21 are sheathed on the first shaft. The convex blades 212 of adjacent first sheets 21 are staggered and stacked in sequence to form a spiral male screw 2 with the side in an arced array configuration.

The female screw 3 comprises a plurality of second sheets 31 that are sequentially stacked. The outer edge of the second sheets 31 is evenly provided with a plurality of inwardly recessed arcuate grooves 312. The second sheets 31 each comprise a second axle hole 311. The diameter of the second axle hole 311 is equal to that of the second shaft. The plurality of second sheets 31 are sheathed on the second shaft. The arcuate grooves 312 of adjacent second sheets 31 are staggered and stacked in sequence to form a spiral female screw 3 with the side in an arced array configuration.

The convex blades 212 of the first sheets 21 and the arcuate grooves 312 of the second sheets 31 engage with each other, and are driven by the drive motor 12 to rotate synchronously.

In operation, the convex blades 212 on the male screw 2 engage with the corresponding arcuate grooves 312 of the female screw 3 in the compression chamber, respectively. The controller 14 controls the start of the drive motor 12. The drive motor 12 drives the gear set 13 to rotate, and the rotation of the gear set 13 drives the first shaft and the second shaft connected thereto, thereby driving the male screw 2 and the female screw 3 to rotate. Due to the mutual engagement between the male screw 2 and the female screw 3 and the high-speed rotation thereof, external air entering the arcuate grooves 312 of the female screw 3 via the air inlet is squeezed and compressed by the convex blades 212 of the male screw 2, thus generating a certain pressure gas. The pressure gas has a high flow rate and then sent out through the air outlet 11. The process is repeated in this way to drive the compressor to operate.

It will be obvious to those skilled in the art that changes and modifications may be made, and therefore, the aim in the appended claims is to cover all such changes and modifications.

What is claimed is:

1. A screw compressor, comprising:
a housing comprising at least one air inlet and at least one air outlet;
a screw rotor being disposed in the housing and comprising a male screw and a female screw that engage with each other; and
a drive motor that drives the screw rotor to rotate;
wherein:
the male screw comprises a plurality of first sheets that are sequentially stacked; an outer edge of each of the plurality of first sheets is provided with a plurality of convex blades, and the convex blades of adjacent first sheets are staggered and stacked in sequence; the male screw is spiral and comprises a side in an arced array configuration;
the female screw comprises a plurality of second sheets that are sequentially stacked; an outer edge of each of the plurality of second sheets is provided with a plurality of inwardly recessed arcuate grooves, and the arcuate grooves of adjacent second sheets are staggered and stacked in sequence; the female screw is spiral and comprises a side in an arced array configuration; and
the convex blades of the first sheets and the arcuate grooves of the second sheets engage with each other.

2. The compressor of claim 1, wherein the drive motor is connected to the screw rotor via a gear set to drive the male and female screws that engage with each other to rotate synchronously.

3. The compressor of claim 2, wherein the gear set comprises two gears that engage with each other.

4. The compressor of claim 1, wherein an offset angle between the convex blades of adjacent first sheets and an offset angle between the arcuate grooves of adjacent second sheets are identical.

5. The compressor of claim 1, wherein the first sheets and the second sheets are both circular, the first sheets stacked on each other are in the shape of a spiral column and forms the male screw; and the second sheets stacked on each other are in the shape of a spiral column and forms the male screw.

6. The compressor of claim 1, wherein the screw compressor further comprises a controller electrically connected to a control end of the drive motor to control a start, shutdown and rotational speed of the drive motor.
